(19) United States
(12) Patent Application Publication
(10) Pub. No.: US 2007/0130578 A1
(43) Pub. Date: Jun. 7, 2007

(54) Thin type optical disk recording and reproducing apparatus and method

(75) Inventors: Hiroshi Ido, Ibaraki (JP); Manabu Tani, Ibaraki (JP); Hideaki Yamanaka, Ibaraki (JP); Yoshiaki Inamura, Ibaraki (JP)

Correspondence Address: BIRCH STEWART KOLASCH & BIRCH, PO BOX 747, FALLS CHURCH, VA, 22040-0747, US

(73) Assignee: HITACHI MAXELL, LTD.

(21) Appl. No.: 11/448,035

(22) Filed: Jun. 7, 2006

(30) Foreign Application Priority Data
Jun. 8, 2005 (JP) 2005-168730
Jul. 1, 2005 (JP) 2005-194278

(51) Int. Cl. G11B 17/028

(52) U.S. Cl. 720/703; 720/704

(57) ABSTRACT

In order to reduce local deflection mainly caused by static electricity generated on a flexible disk which is capable of optical recording and reproducing and is mounted on an attitude control plate, and to perform stable focusing in the optical recording and reproducing, according to the present invention, a spacer is incorporated into the attitude control plate having a penetrating vents for air inflow, the flexible disk capable of the optical recording and reproducing is mounted to rotate integrally to generate a stable air flow in a gap secured between the flexible disk and the attitude control plate so as to equilibrate a force due to the air flow and gravity and a centrifugal force of the flexible disk, and electrostatic repulsion, so that a stably balanced state of the flexible disk is maintained.

### BACKGROUND OF THE INVENTION

1. Field of the Invention

The present invention relates to a recording and reproducing apparatus of a thin type optical disk provided with a mechanism for keeping an attitude of the thin type optical disk and for performing an optical correction for recording and reproduction, and in particular, to a recording and reproducing apparatus and method of the thin type optical disk provided with a mechanism for preventing deflection of the thin type optical disk from generating during recording and reproduction thereof by placing a plate-like member for keeping the attitude and/or for the optical correction along the thin type optical disk.

2. Description of the Prior Art

Conventionally, a business enterprise or the like handling important and voluminous data has adopted a data management system relying only on a magnetic tape, a hard disk, etc. However, the magnetic tape requires periodic maintenance to be performed for the sake of preventing adhesion between the tapes and the like, which entails high cost. As for the hard disk, a drive and a magnetic recording medium make a pair, and therefore, if the drive fails, it can not reproduce information recorded on the magnetic recording medium which makes the pair with the drive. For this reason, a countermeasure must be taken, such as mirroring the data in case of the failure of the drive. However, even if such a countermeasure is taken, recovery of the data may be impossible in the case where a mirrored disk and an original disk fail at the same time or in the case where the mirrored disk further fails before completing the recovery of the data on occurrence of the failure.

Thus, attention has been recently focused on a data management system partially using an optical recording medium (optical disk) of which maintenance is easy and of which reliability is high. The data management system partially using the optical disk is designed to use the hard disk for data which is frequently rewritten and use the optical disk as to data which is accessed less often but requires its information to be stored for a long period of time. The optical disk is basically maintenance-free only if characteristic degradation due to dust and the like is prevented. Even if the drive for recording and reproduction fails, there is no problem, unlike the hard disk, if the optical disk is moved to another drive. To be more specific, it is possible, by using the optical disk, to dramatically reduce time required for troubleshooting and significantly decrease a risk of losing important information.

Thus, the optical disk has already occupied an important position as a recording medium of which maintenance is easy and of which reliability is high. However, because of recent development of information and communication technology, expectations are placed on further improvement in easiness of handling and increase in storage capacity. Here, to increase the storage capacity of the optical disk, it is necessary to narrow a track pitch and also narrow spacing of recording marks. However, if the track pitch and spacing of recording marks become smaller than a spot diameter λ/NA (λ: wavelength of a laser beam, NA: numeric aperture of a stop down lens) of a laser beam, multiple recording marks get in one optical spot and therefor individual recording marks can not be identified. To be more specific, the storage capacity of the optical disk has a limit according to the wavelength of the laser beam and the numeric aperture. It is impossible to expand the capacity over the limit unless a special method is taken.

As for the methods for expanding the capacity over the limit, various attempts are made, such as optical super-resolution, a magnetic super-resolution method, a super lens, and a hologram. It is possible, as a most efficient method, to point out the method of reducing thickness of an optical disk substrate and increasing the storage capacity per volume. As described in JP-A-62-212935, JP-A-2003-331561 and JP-A-2003-91970 for instance, a thin type optical disk recording and reproducing apparatus of which storage capacity per volume is several times larger than that of a conventional optical disk is realized by configuring the recording and reproducing apparatus by combining a thin type optical disk with a stabilizer for rotating the thin type optical disk stably without generating the deflection of the thin type optical disk. The optical disk used here consisting of a thin substrate of 100 μm thickness or so is called a “flexible disk” hereinafter.

In addition to using the stabilizer as described above, it is possible, as another method of using the flexible disk, to point out the method of supporting the flexible disk by using a disk-shaped glass plate of which planar dimensions and shape are almost the same as the flexible disk. The glass plate is made of optical glass. If the laser beam for recording and reproduction is radiated on the flexible disk via the glass plate, the recording and reproduction can be performed as with the conventional optical disk (in which compatibility with an optical system of a conventional optical disk recording and reproducing apparatus is secured). For instance, the inventors have confirmed that, if the flexible disk of 100 μm thickness to which a DVD pit pattern is transferred thereto and on which the disk-shaped optical glass plate of 500 μm thickness is placed so as to approximately overlap those centers with each other is reproduced using a commercially available DVD drive, it is possible to reproduce the information recorded as a pit pattern on the flexible disk. The disk-shaped optical glass plate used here supports the flexible disk and also makes an optical correction to the laser beam for recording and reproduction, and thus it is called as “attitude control and optical correction plate” hereafter.

In the case of the recording and reproducing apparatus using the flexible disk, it is overwhelmingly advantageous to use the latter attitude control and optical correction plate because it can construct a system more easily.

### BRIEF SUMMARY OF THE INVENTION

According to examination by the inventors of the present invention, however, it turned out that a flexible disk shows different behavior from a conventional optical disk substrate since the flexible disk has low stiffness and is apt to have static electricity. Here, consideration is given to the case where one or both of the flexible disk and the attitude control and optical correction plate have the static electricity. When the flexible disk is set on the attitude control and optical correction plate in such a state, the entire flexible disk does not become flat, and areas in which air is trapped between the flexible disk and the attitude control and optical correction plate are formed (this phenomenon is referred to as occurrence of an air trap).

It is thinkable that such an air trap occurs as follows.

(I) A certain portion of the flexible disk adheres to the attitude control and optical correction plate due to the static electricity.

(II) A larger amount of the static electricity becomes exerted on that adhering portion than other areas, so that peripheral portions thereof adhere one after another to expand the adhering area.

(III) As the adhering area expands, a distortion occurs in the flexible disk so that there appears a portion in which a force due to the distortion exceeds the force due to the static electricity.

(IV) No adhering portion is formed around a significantly distorted portion, and an adhering area is formed at a position a little apart.

Next, a description will be given as to problems arising in recording and reproducing information in the case where the air trap described above occurs. An amount of displacement y(t) at one point on a substrate in a z-axis direction (vertical direction to a substrate surface) in a state that a normal thick substrate rotates is represented as follows.
y(t)=δsin ωt
where
δ; maximum amount of displacement
ω; angular velocity
t; time

Acceleration a in the z-axis direction in this case is generally called surface deflection acceleration, which is represented as follows.
a=y(t)″=−δω² sin ωt
(the amount of displacement y(t) is differentiated by the time t twice)

Here, the maximum amount of displacement δ is represented as follows if represented in decibel.
δ=20 log(a/ω²)=−40 log(f) −40 log(2π)+20 log(a)
where
f; frequency

A graph of FIG. 11 shows the relationship between a frequency and a surface deflection amount for the normal thick substrate (shown in the solid line in FIG. 11). In the drive of the recording and reproducing apparatus, an actuator and an objective lens follow the deflection (deflection acceleration) of the substrate by means of a focus servo so as to control a laser beam to be correctly focused on an information surface. The focus servo is designed to have a sufficient servo characteristic (indicated in the dashed line in FIG. 11) according to the frequency so that the actuator and objective lens can follow the deflection easily.

In the case of using the flexible disk of 100 μm substrate thickness (thin type substrate) and the attitude control and optical correction plate, local deflection occurs due to the “air trap.” Furthermore, the air trap does not disappear even if the disk rotates, and remains between the flexible disk and the attitude control and optical correction plate. The amount of displacement y(t) at one point in the z-axis direction on the flexible disk in this case is represented as follows.
y(t)=δsin ωt+
(high-order displacement amount due to local deflection)

Since an element obtained by differentiate the second term (high-order displacement amount due to local deflection) in the above formula twice is newly added to of the deflection acceleration “a” in the z-axis direction in this case, the deflection amount of the flexible disk indicates a frequency characteristic different from the case of using the normal thick substrate (indicated in the dotted line in FIG. 11 for instance). Therefore, in the case of using the flexible disk, focus following by the focus servo is more difficult than the case of using the normal thick substrate.

As described above, in the case of the recording and reproducing apparatus using the flexible disk and the attitude control and optical correction plate, it is an important object to take measures against the air trap due to the static electricity for the sake of performing stable focusing. Thus, the present invention provides a technique for reducing the local deflection of the flexible disk on the recording and reproducing apparatus using the flexible disk and the attitude control and optical correction plate.

As a result of an earnest research in view of the object, the inventors noted that the occurrence of the air trap can be prevented by generating constant air flow between the flexible disk and the attitude control and optical correction plate during disk rotation, which led to the present invention.

To be more specific, the present invention provides a recording and reproducing apparatus including a thin type optical disk and an attitude control plate having its center placed coaxially on a rotation axis of the thin type optical disk, in which a spacer is provided on a surface of the attitude control plate opposed to the thin type optical disk so as to secure a fixed clearance between the attitude control plate and the thin type optical disk during disk rotation, and the attitude control plate has one or more penetrating vents at positions closer to an outer circumference than a mounting position of the spacer.

The present invention provides a recording and reproducing apparatus including a thin type optical disk and an attitude control plate having its center placed coaxially on a rotation axis of the thin type optical disk on one of surfaces opposed to the thin type optical disk, in which a spacer is provided on the surface of the attitude control plate opposed to the thin type optical disk so as to secure a fixed clearance between the attitude control plate and the thin type optical disk during disk rotation, and the attitude control plate has one or more penetrating vents at positions closer to an outer circumference than a mounting position of the spacer.

The present invention provides a recording and reproducing apparatus including a thin type optical disk and a pair of attitude control plates having the centers placed coaxially on a rotation axis of the thin type optical disk on both sides of a rotation surface of the thin type optical disk, in which a spacer is provided on a surface of each of the attitude control plates opposed to the thin type optical disk so as to secure a fixed clearance between each of the attitude control plates and the thin type optical disk during disk rotation, and the attitude control plate has one or more penetrating vents at positions closer to an outer circumference than a mounting position of the spacer.

In the thin type optical disk recording and reproducing apparatus of the present invention, at least one of the attitude control plates performs optical correction with respect to a recording and reproducing laser radiated on the thin type optical disk, the recording and reproducing apparatus is characterized by performing the recording and reproduction by radiating the recording and reproducing laser on the thin type optical disk through the attitude control plate performing the optical correction. It is thereby possible to perform the recording and reproduction of the thin type optical disk by means of a conventional optical system such as a DVD. Also, it is possible to make the apparatus configuration compact by the attitude control plate doubling the optical correction plate.

The thin type optical disk recording and reproducing apparatus of the present invention is provided with a clamp for fixing the attitude control plates and the thin type optical disk to a disk rotation axis, and is characterized in that the clamp has one or more vents penetrating in the disk rotation axis direction, and the spacer has one or more vents penetrating in a radial direction of the attitude control plates and the thin type optical disk in a space between the attitude control plates and the thin type optical disk. It is thereby possible to generate a constant air flow directed toward the outer circumference direction from the center in the space between the attitude control plates and the thin type optical disk.

The thin type optical disk recording and reproducing apparatus of the present invention is characterized by including a spacer having one or more vents penetrating in the rotation axis direction of the attitude control plates and the thin type optical disk in the space between the attitude control plates and the thin type optical disk. It is thereby possible to generate a constant air flow directed toward the outer circumference direction from the center in the space between the attitude control plates and the thin type optical disk.

In the thin type optical disk recording and reproducing apparatus of the present invention, the attitude control plate is characterized by having a larger outer diameter than the thin type optical disk. It is experimentally known that a higher attitude-stabilizing effect is obtained by this configuration.

The thin type optical disk recording and reproducing apparatus of the present invention is characterized in that an antistatic finish is applied on at least one surface of the attitude control plate and the thin type optical disk. Also, it is desirable to form antistatic coats consisting of the same composition on the opposed surfaces of the attitude control plate and the thin type optical disk. It is thereby possible to prevent generation of the static electricity which causes the local deflection.

The present invention also provides a method of controlling an attitude of a thin type optical disk in a recording and reproducing apparatus including the thin type optical disk and an attitude control plate coaxially arranged on a rotation axis of the thin type optical disk, characterized in that a clamp for fixing the attitude control plate and the thin type optical disk to a disk rotation axis is provided with one or more vents penetrating in the disk rotation axis direction, a spacer for securing a fixed clearance between the attitude control plate and the thin type optical disk is provided on a surface of the attitude control plate opposed to the thin type optical disk, the spacer is provided with one or more vents penetrating in a radial direction of the attitude control plate and the thin type optical disk, and the attitude control plate and thin type optical disk rotate together and thereby generate a constant air flow between the attitude control plate and the thin type optical disk.

The present invention also provides a method of controlling an attitude of a thin type optical disk in a recording and reproducing apparatus including the thin type optical disk and an attitude control plate coaxially arranged with respect to a rotation axis of the thin type optical disk, characterized in that a spacer for securing a fixed clearance between the attitude control plate and the thin type optical disk is provided on a surface of the attitude control plate opposed to the thin type optical disk, the attitude control plate has one or more penetrating vents at a position closer to an outer circumference than a mounting position of the spacer, and the attitude control plate and thin type optical disk rotate together and thereby generate a constant air flow between the attitude control plate and the thin type optical disk.

The present invention also provides a method of controlling a position of a thin type optical disk in a recording and reproducing apparatus including the thin type optical disk and an attitude control plate having its center coaxially placed on a rotation axis of the thin type optical disk, characterized in that the spacer has one or more vents penetrating in a rotation axis direction of the attitude control plate and the thin type optical disk in a space between the attitude control plate and the thin type optical disk, and the attitude control plate and thin type optical disk rotate together and thereby generate a constant air flow between the attitude control plate and the thin type optical disk.

As described above, the thin type optical disk recording and reproducing apparatus of the present invention can effectively prevent the air trap due to the static electricity generated between the flexible disk and the attitude control and optical correction plate. Therefore, the local deflection of the flexible disk is reduced, and high recording and reproducing performance is realized.

A detailed description will be given with reference to the attached drawings hereinafter as to preferred embodiments for implementing the thin type optical disk recording and reproducing apparatus and method of the present invention.

### BRIEF DESCRIPTION OF THE SEVERAL VIEWS OF THE DRAWINGS

FIGS. 1A to 1D are sectional views schematically showing a first configuration example of a rotating mechanism portion of a thin type optical disk recording and reproducing apparatus;

FIGS. 2A to 2D are sectional views schematically showing a second configuration example of the rotating mechanism portion of the thin type optical disk recording and reproducing apparatus;

FIGS. 3A to 3D are sectional views schematically showing a third configuration example of the rotating mechanism portion of the thin type optical disk recording and reproducing apparatus;

FIG. 4 is a sectional view schematically showing a fourth configuration example of the rotating mechanism portion of the thin type optical disk recording and reproducing apparatus;

FIG. 5 is a sectional view schematically showing a fifth configuration example of the rotating mechanism portion of the thin type optical disk recording and reproducing apparatus;

FIG. 6 is a sectional view schematically showing a sixth configuration example of the rotating mechanism portion of the thin type optical disk recording and reproducing apparatus;

FIG. 7 shows a focus error signal in the case of reproducing an optical disk using 1.2 mm thick substrate in a conventional recording and reproducing apparatus;

FIG. 8 shows a focus error signal in the case of reproducing a flexible disk in the conventional recording and reproducing apparatus;

FIG. 9 shows a focus error signal in the case of reproducing the flexible disk in the thin type optical disk recording and reproducing apparatus of the present invention;

FIG. 10 shows a focus error signal in the case of using an attitude control plate of a different outer diameter in the thin type optical disk recording and reproducing apparatus of the present invention; and

FIG. 11 is a graph showing a relation between a frequency and a deflection amount as to a normal thick substrate and a thin type substrate.

### DETAILED DESCRIPTION OF THE INVENTION

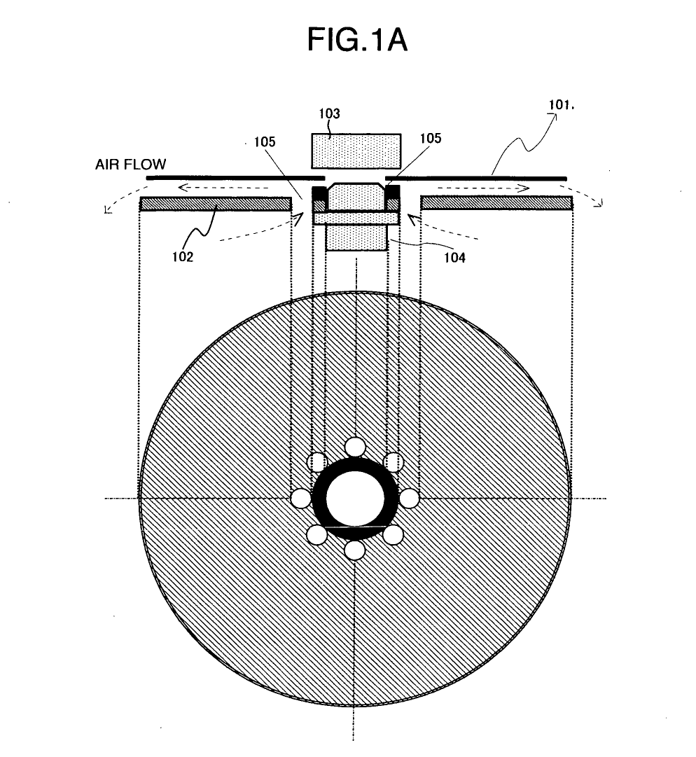

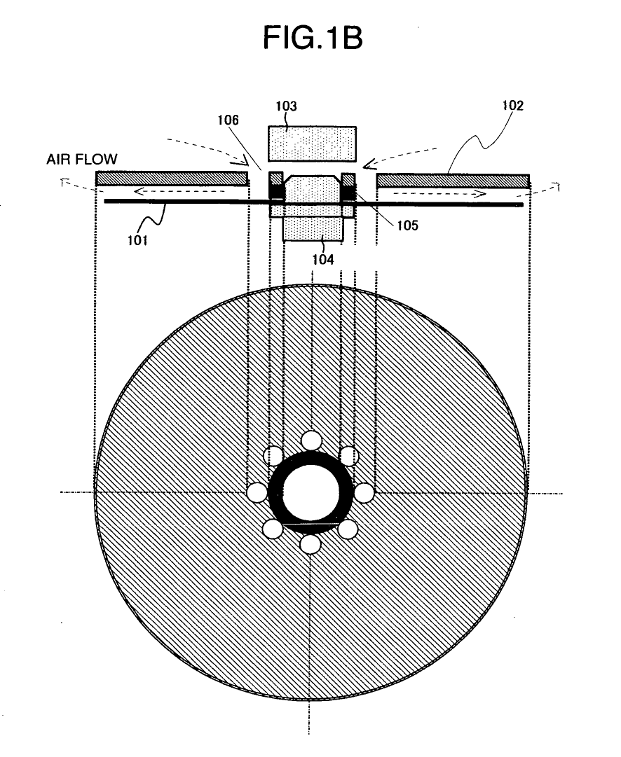

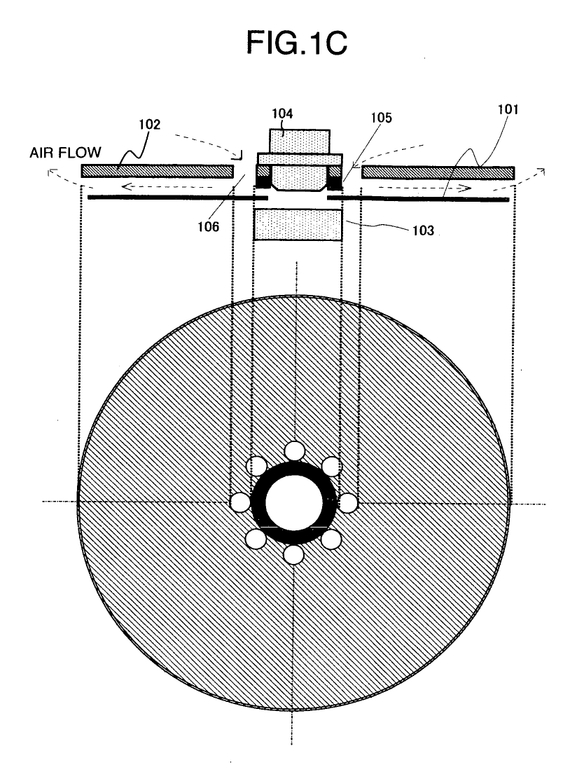

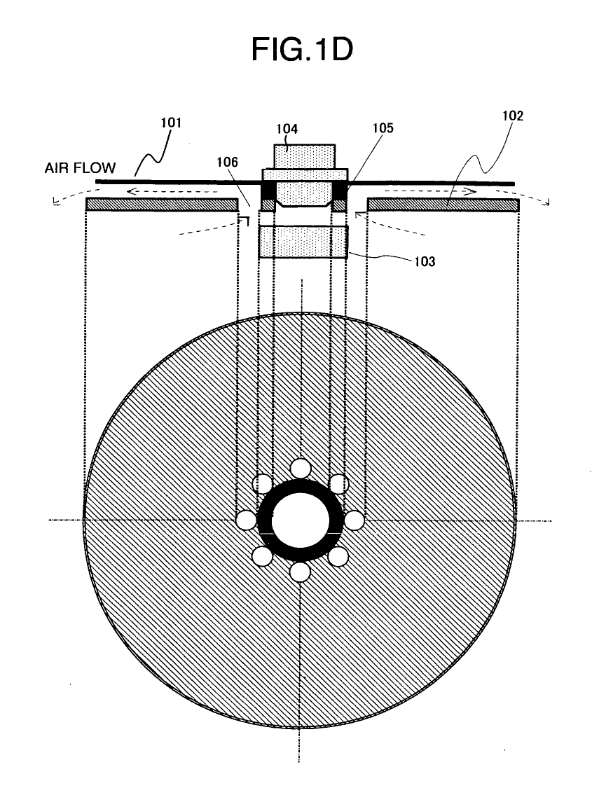

FIGS. 1A to 1D, FIGS. 2A to 2D, FIGS. 3A to 3D and FIGS. 4 to 6 are drawings schematically showing configuration examples of a rotating mechanism portion of a thin type optical disk recording and reproducing apparatus. The rotating mechanism shown in the drawings includes a flexible disk 101, an attitude control plate 102, a clamp 103 and a turntable 104. The flexible disk 101, the attitude control plate 102 and a spacer 105 are sandwiched between the clamp 103 and the turntable 104 so as to be rotated by a rotary drive of the turntable 104.

Among these, FIGS. 1A to 1D show a state that the attitude control plate 102 has vents at penetrating positions thereon closer to an outer circumference than a mounting position of the spacer 105 separately prepared. FIG. 1A shows that the “turntable”, “attitude control plate”, “spacer”, “flexible disk”, and “clamp” are arranged in this order from the bottom, FIG. 1B shows that the “turntable”, “flexible disk”, “spacer”, “attitude control plate”, and “clamp” are arranged in this order from the bottom, FIG. 1C shows that the “clamp”, “flexible disk”, “spacer”, “attitude control plate” and “turntable” are arranged in this order from the bottom, and FIG. 1D shows that the “clamp”, “attitude control plate”, “spacer”, “flexible disk” and “turntable” are arranged in this order from the bottom. Such arrangements of the spacer 105 allow air to move in and out through a gap of the spacer 105 even in a state that the spacer 105 is pressed against the flexible disk 101. Furthermore, during disk rotation, an air flow is generated from an inner circumferential edge toward an outer circumferential edge between the flexible disk 101 and the attitude control plate 102. Thus, local deflection occurring due to static electricity is effectively eliminated. The number, diameter and the like of the penetrating vents should be determined so as not to impair strength of the attitude control plate 102 while it is more suitable to provide multiple vents circumferentially in a rotation centrosymmetric situation.

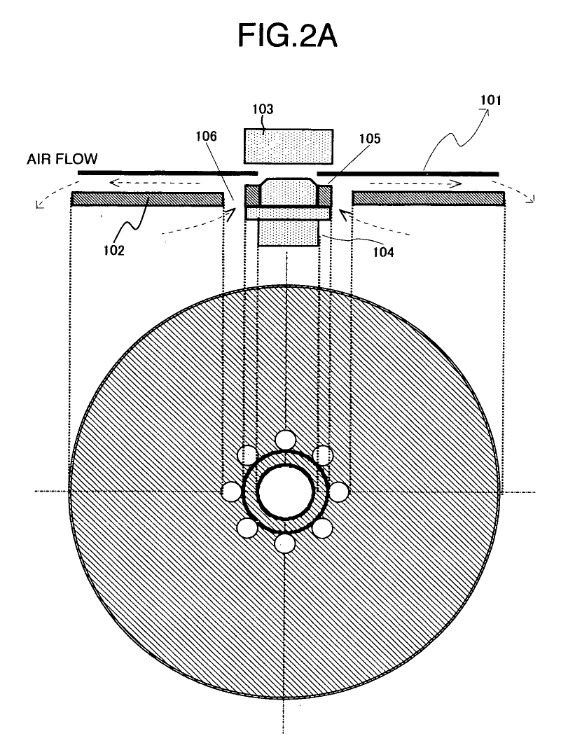

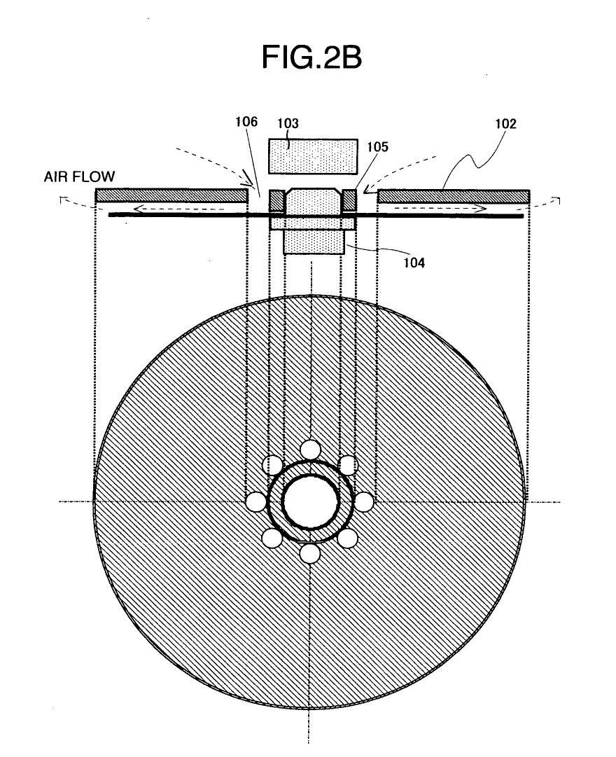

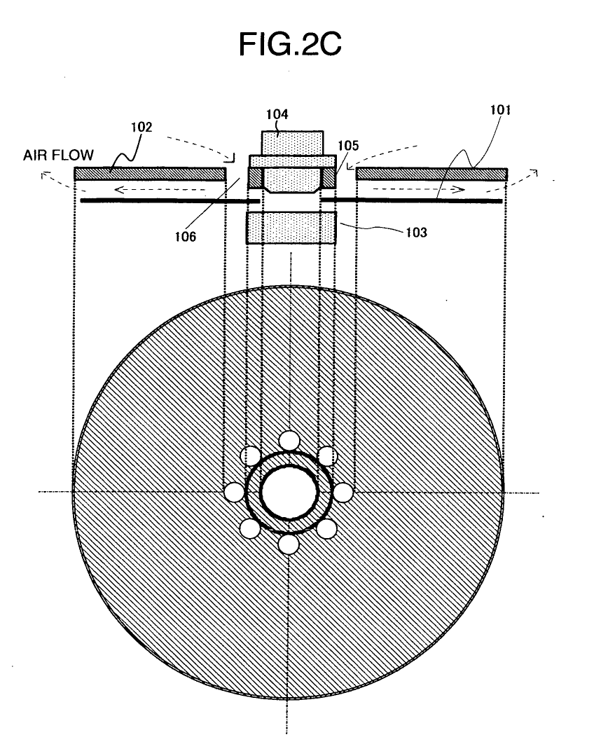

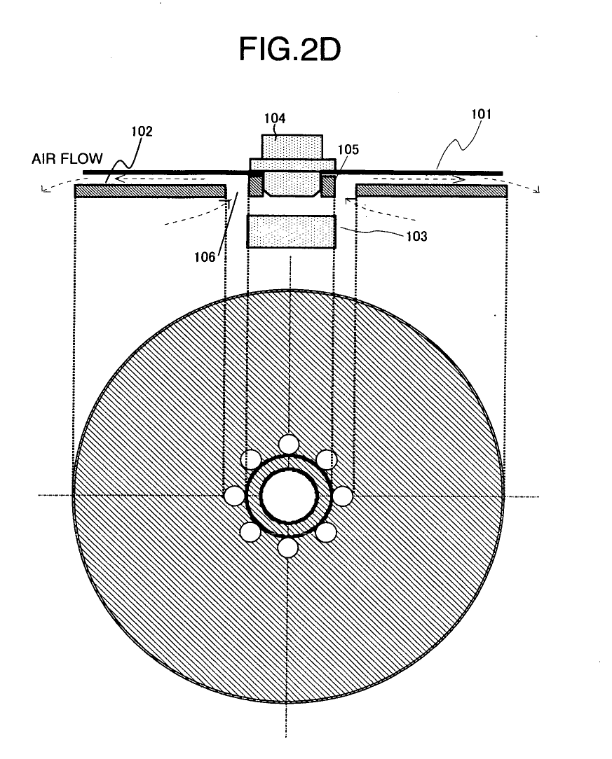

Next, FIGS. 2A to 2D show a state that a convex portion is integrally formed on the attitude control plate 102 and is used as a spacer 105, and the attitude control plate 102 further has penetrating vents at positions closer to the outer circumference than the convex position of the spacer. FIG. 2A shows that the “turntable”, “attitude control plate”, “spacer”, “flexible disk” and “clamp” are arranged in this order from the bottom, FIG. 2B shows that the “turntable”, “flexible disk”, “spacer”, “attitude control plate” and “clamp” are arranged in this order from the bottom, FIG. 2C shows that the “clamp”, “flexible disk”, “spacer”, “attitude control plate”, and “turntable” are arranged in this order from the bottom, and FIG. 2D shows that the “clamp”, “attitude control plate”, “spacer”, “flexible disk” and “turntable” are arranged in this order from the bottom. As previously described, during the disk rotation, the air flow is generated from the inner circumferential edge toward the outer circumferential edge between the flexible disk 101 and the attitude control plate 102. Thus, the local deflection occurring due to the static electricity is effectively eliminated.

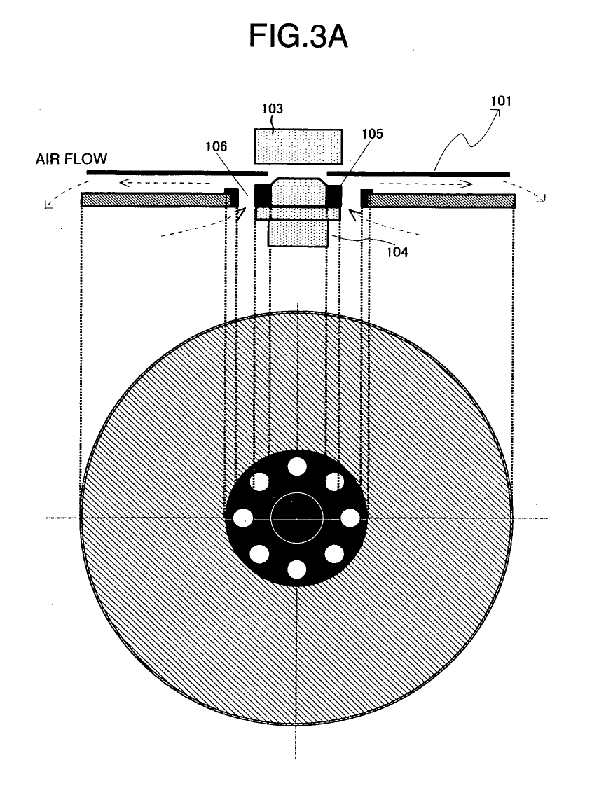

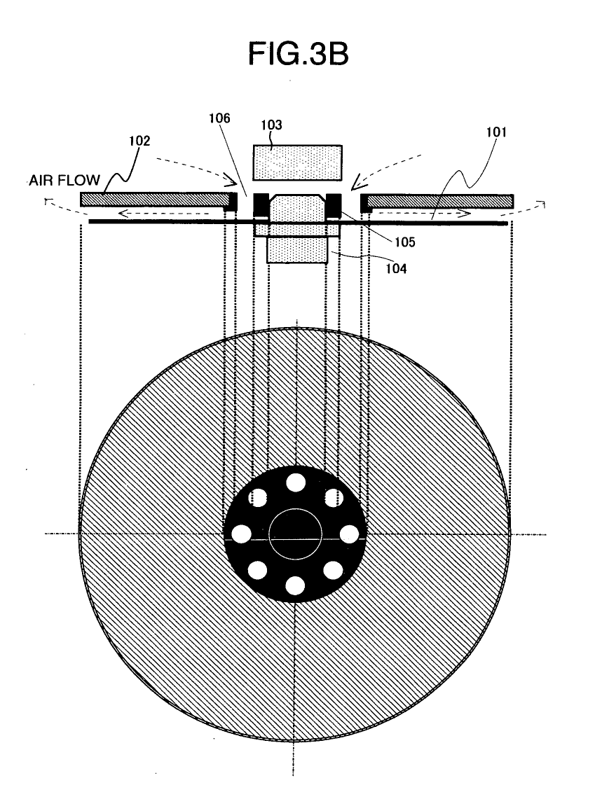

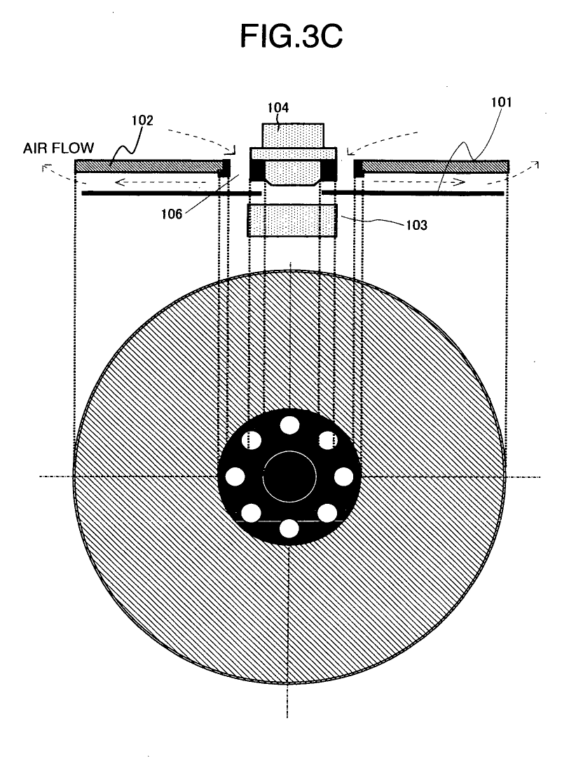

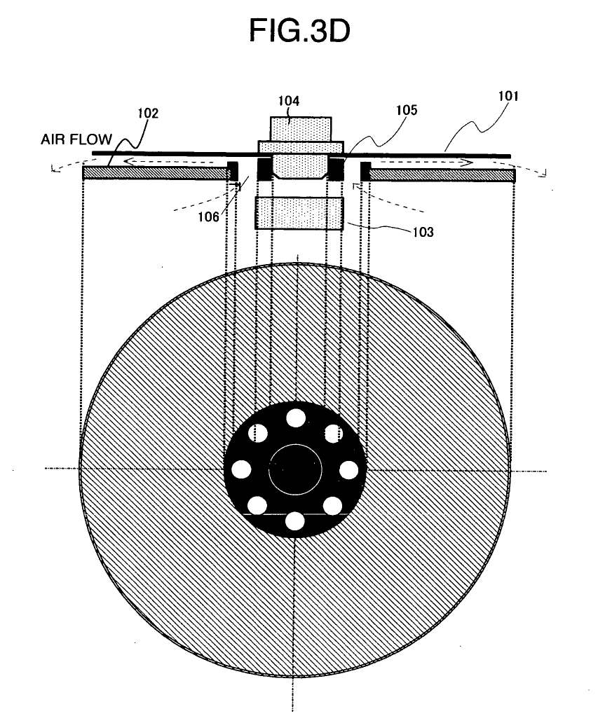

Next, in FIGS. 3A to 3D, a jig provided with a convex portion and through holes is prepared as a spacer 105. A state that the penetrating vents at the positions closer to the outer circumference than the convex position of the spacer are provided is shown. The attitude control plate 102 has the spacer 105 bonded thereto. Furthermore, FIG. 3A shows that the “turntable”, “attitude control plate”, “spacer”, “flexible disk”, and “clamp” are arranged in this order from the bottom, FIG. 3B shows that the “turntable”, “flexible disk”, “spacer”, “attitude control plate” and “clamp” are arranged in this order from the bottom, FIG. 3C shows that the “clamp”, “flexible disk”, “spacer”, “attitude control plate”, and “turntable” are arranged in this order from the bottom, and FIG. 3D shows that the “clamp”, “attitude control plate”, “spacer”, “flexible disk” and “turntable” are arranged in this order from the bottom. As previously described, during the disk rotation, the air flow is generated from the inner circumferential edge toward the outer circumferential edge between the flexible disk 101 and the attitude control plate 102. Thus, the local deflection occurring due to the static electricity is effectively eliminated.

In FIG. 4, the attitude control plate 102 is placed on the topside of the flexible disk 101 in addition to the configuration shown in FIG. 1A. The spacer 105 along the inner circumferential edge is placed on the surface of the attitude control plate 102 opposed to the flexible disk 101. During the disk rotation, the air flow is generated from the inner circumferential edge toward the outer circumferential edge between the flexible disk 101 and the attitude control plates 102 placed both above and below the flexible disk respectively. Thus, the local deflection occurring due to the static electricity is effectively eliminated. Furthermore, according to this configuration, negative pressures are generated approximately evenly on both sides of the flexible disk 101 due to the air flow, and it is thereby possible to stabilize the position of the flexible disk 101 more effectively. For instance, if a part of the flexible disk 101 hangs downward, a higher negative pressure is generated in an upper part thereof so that a force for lifting up the hanging part is exerted. The faster the rotation is, the more significant this action becomes. The same effect can be obtained even if the spacer is integrally formed with the attitude control plate 102, or is provided with the convex position and penetrating vents as previously described.

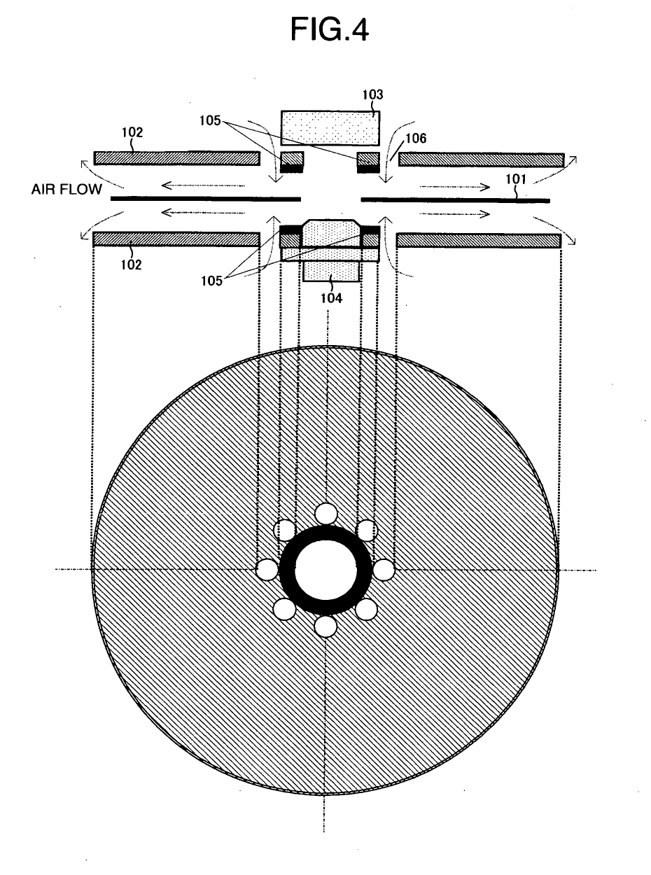

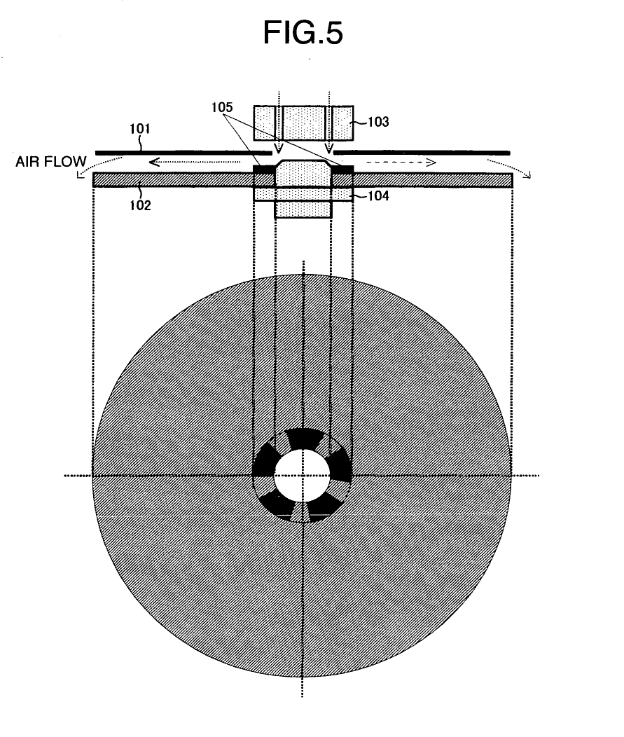

In FIG. 5, multiple fan-shaped spacers 105 are placed along the inner circumferential edge of the attitude control plate 102. The penetrating vents are provided in the clamp 103. It is thereby possible to secure inlets of air around the rotation axis of the disk so that a high position-stabilizing effect can be expected.

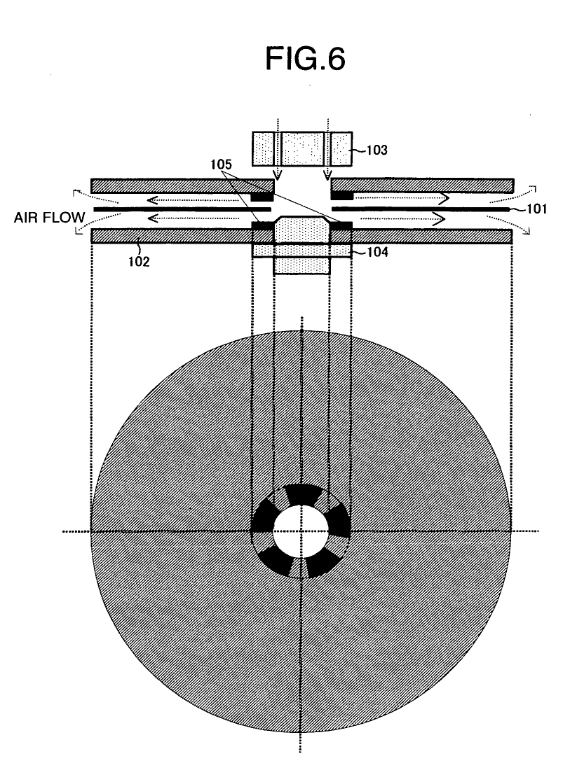

FIG. 6 has a configuration in which the methods shown in FIGS. 4 and 5 are combined.

As for the configuration examples of FIGS. 1A to 1D, FIGS. 2A to 2D, FIGS. 3A to 3D and FIGS. 4 to 6, it is possible to provide a function of performing an optical correction to a recording and reproducing laser radiated on a thin type optical disk by rendering at least one of the attitude control plates 102 and at least an information area transparent. For instance, in the case of reproducing the flexible disk of 100 μm thickness having a DVD pit pattern transferred thereto, a glass plate of 500 μm thickness can be used as an attitude control plate to allow the thin type optical disk to be recorded and reproduced by a conventional optical system such as a DVD. As for the configurations shown in FIGS. 4 and 6, it is possible to use a both-side recording type flexible disk if both the upper and lower attitude control plates 102 have the optical correction function.

### (Embodiment)

The flexible disk 101 capable of optical recording and reproducing is made by laminating a pigment recording layer, a metallic reflective layer containing silver as its major component, and a protective coat on a polycarbonate film of 100 μm thickness, and is made as a doughnut-shaped plate having an outer diameter of φ120 mm and an inner diameter of φ15 mm.

The rotating mechanism portion of the thin type optical disk recording and reproducing apparatus has been created according to the above described embodiment, and various experiments have been performed to evaluate its performance. Since an air trap occurring when using the flexible disk is observed as deflection, generation of a focus error signal on the recording and reproducing apparatus just has to be checked.

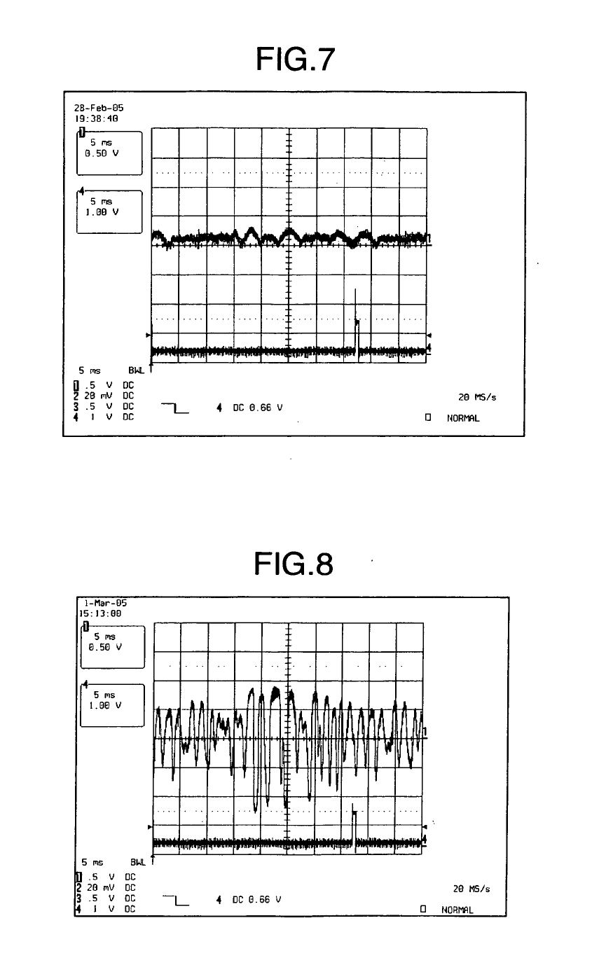

First, an optical disk using a substrate of 1.2 mm thickness and the flexible disk are reproduced in a conventional recording and reproducing apparatus, and the generating situation of a focus error signal is observed in each of the cases. FIGS. 7 and 8 show the results respectively. As is apparent from FIGS. 7 and 8, the focus error signals are generated to a far greater extent in the case of using the flexible disk than the case of using the 1.2 mm thickness optical disk. Thus, it is understandable that the air traps are occurring in no small measure.

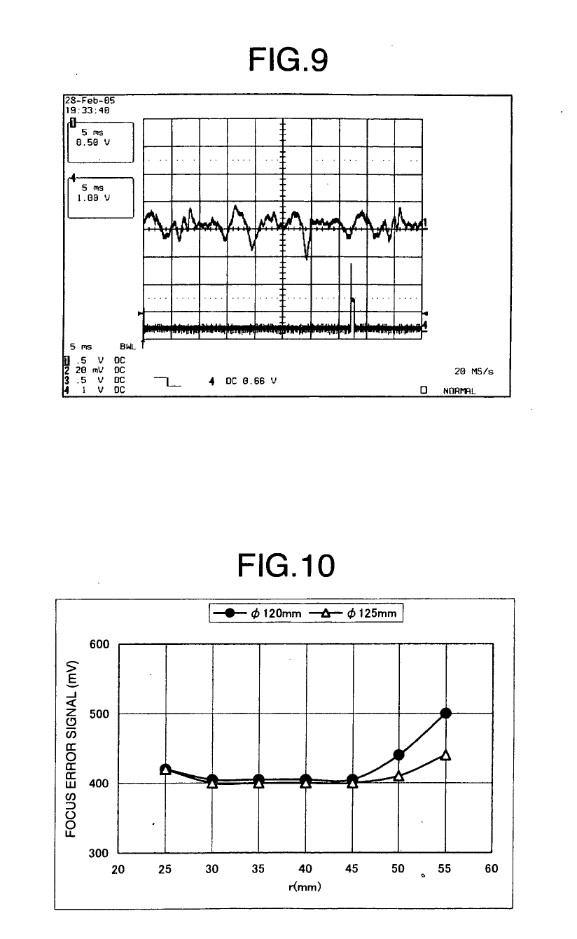

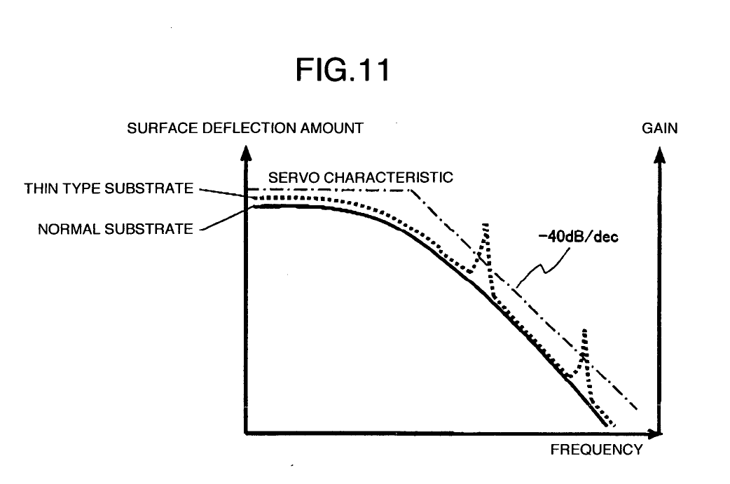

Next, the situation of focus error signal generation is observed as to the thin type optical disk recording and reproducing apparatus created according to the above embodiment. As shown in FIG. 9, in the case of the thin type optical disk recording and reproducing apparatus created according to the above embodiment, the generation of the focus error signals is significantly suppressed in comparison with the conventional flexible disk reproducing apparatus. To be more specific, the thin type optical disk recording and reproducing apparatus of this embodiment can generate the air flow between the flexible disk and the attitude control plate and thereby reduce the occurrences of the air trap and eliminate the air trap effectively even if it occurs.

Next, the attitude control plates having outer diameters of φ120 mm and φ125 mm are prepared and observed respectively. FIG. 10 shows a result thereof. As is apparent from FIG. 10, a higher attitude-stabilizing effect can be obtained by rendering the outer diameters of the attitude control plates a little larger than that of the flexible disk. If attention is focused on the outer circumferential portion of the flexible disk, it is expected that a turbulent flow of the air is generated in conjunction with the rotation of the flexible disk and the attitude control plate. For this reason, the turbulent flow of the air supposedly generates an unsteady force of the flexible disk, which results in increase in a deflection amount of the flexible disk. It is considered that the attitude control plate having an outer diameter of φ120 mm is more susceptible to the effects of the turbulent flow and has a larger deflection amount than the plate having an outer diameter of φ125 mm.

Next, a SiN thin film is sputtered by 3 nm on both sides of the attitude control plate 102 and the flexible disk 101 obtained in such a way. The attitude control plate 102 (referred to as an attitude control plate A) is fixed with the spacer 105 and the flexible disk 101 as shown in FIG. 1A. A maximum value of the focus error signal is 440 mV when measured by rotating a player at 4000 rpm. The maximum value of the focus error signal is 550 mV when measured likewise by using an equivalent of the attitude control plate other than omission of SiN thin film formation (referred to as an attitude control plate B). Therefore, a higher attitude-stabilizing effect can be obtained by forming a film of the same composition on the opposed surfaces of the attitude control plate and the thin type optical disk. It is considered that the attitude control plate A can put the respective opposed surfaces of the flexible disk and the attitude control plate in a charged state of the same symbol to generate electrostatic repulsion mutually so that those do not stick to each other, while the attitude control plate B has the focus error signal grown larger due to static unstableness.

As described above, a description is given as to the concrete embodiments of the thin type optical disk recording and reproducing apparatus of the present invention. However, the present invention is not limited thereto. It is possible for a person skilled in the art to add various changes and improvements to the configurations and functions of the inventions related to the embodiment or other embodiments without departing from the scope of the present invention.

1. A recording and reproducing apparatus comprising a thin type optical disk, and an attitude control plate of which center is placed coaxially with a rotation axis of the thin type optical disk, wherein
a spacer is provided on a surface of the attitude control plate opposed to the thin type optical disk so as to secure a certain clearance between the attitude control plate and the thin type optical disk during disk rotation, and
the attitude control plate comprises one or more penetrating vents at a position closer to an outer circumference than a mounting position of the spacer.

2. A recording and reproducing apparatus comprising a thin type optical disk, and an attitude control plate of which center is placed coaxially with a rotation axis of the thin type optical disk, the attitude control plate being provided on one of surfaces opposed to the thin type optical disk, wherein
a spacer is provided on the surface of the attitude control plate opposed to the thin type optical disk so as to secure a certain clearance between the attitude control plate and the thin type optical disk during disk rotation, and
the attitude control plate comprises one or more penetrating vents at a position closer to an outer circumference than a mounting position of the spacer.

3. A recording and reproducing apparatus comprising a thin type optical disk, and a pair of attitude control plates of which centers are placed coaxially with a rotation axis of the thin type optical disk, wherein
a spacer is provided on a surface of each of the attitude control plates opposed to the thin type optical disk so as to secure a certain clearance between the attitude control plate and the thin type optical disk during disk rotation, and
the attitude control plate comprises one or more penetrating vents at a position closer to an outer circumference than a mounting position of the spacer.

4. A recording and reproducing apparatus comprising a thin type optical disk, and a pair of attitude control plates of which centers are placed coaxially with a rotation axis of the thin type optical disk, wherein
the recording and reproducing apparatus comprises a clamp for fixing the attitude control plates and the thin type optical disk to the disk rotation axis, the clamp comprising one or more vents penetrating in the disk rotation axis direction, and
the spacer comprises one or more vents penetrating in a radial direction of the attitude control plates and the thin type optical disk in a space between the attitude control plates and the thin type optical disk.

5. The recording and reproducing apparatus according to claim 1 comprising the attitude control plate on one of surfaces opposed to the thin type optical disk, wherein
the attitude control plate performs optical correction with respect to a recording and reproducing laser radiated on the thin type optical disk, and
the recording and reproducing apparatus performs recording and reproducing by radiating the recording and reproducing laser on the thin type optical disk through the attitude control plate performing the optical correction.

6. The recording and reproducing apparatus according to claim 2 comprising the attitude control plate on one of the surfaces opposed to the thin type optical disk, wherein
the attitude control plate performs optical correction with respect to a recording and reproducing laser radiated on the thin type optical disk, and
the recording and reproducing apparatus performs recording and reproducing by radiating the recording and reproducing laser on the thin type optical disk through the attitude control plate performing the optical correction.

7. The recording and reproducing apparatus according to claim 3, wherein at least one of the attitude control plates performs optical correction with respect to a recording and reproducing laser radiated on the thin type optical disk, and the recording and reproducing apparatus performs recording and reproducing by radiating the recording and reproducing laser on the thin type optical disk through the attitude control plate performing the optical correction.

8. The recording and reproducing apparatus according to claim 4, wherein at least one of the attitude control plates performs optical correction with respect to a recording and reproducing laser radiated on the thin type optical disk, and the recording and reproducing apparatus performs recording and reproducing by radiating the recording and reproducing laser on the thin type optical disk through the attitude control plate performing the optical correction.

9. The recording and reproducing apparatus according to claim 1, wherein antistatic finish is applied on at least one surface of the attitude control plate and the thin type optical disk.

10. The recording and reproducing apparatus according to claim 2, wherein antistatic finish is applied on at least one surface of the attitude control plate and the thin type optical disk.

11. The recording and reproducing apparatus according to claim 3, wherein antistatic finish is applied on at least one surface of the attitude control plates and the thin type optical disk.

12. The recording and reproducing apparatus according to claim 4, wherein antistatic finish is applied on at least one surface of the attitude control plates and the thin type optical disk.

13. The recording and reproducing apparatus according to claim 5, wherein antistatic finish is applied on at least one surface of the attitude control plate and the thin type optical disk.

14. The recording and reproducing apparatus according to claim 6, wherein antistatic finish is applied on at least one surface of the attitude control plate and the thin type optical disk.

15. The recording and reproducing apparatus according to claim 7, wherein antistatic finish is applied on at least one surface of the attitude control plates and the thin type optical disk.

16. The recording and reproducing apparatus according to claim 8, wherein antistatic finish is applied on at least one surface of the attitude control plates and the thin type optical disk.

17. The recording and reproducing apparatus according to claim 1, wherein antistatic coatings having the same composition are formed on the opposed surfaces of the attitude control plate and the thin type optical disk.

18. The recording and reproducing apparatus according to claim 2, wherein antistatic coatings having the same composition are formed on the opposed surfaces of the attitude control plate and the thin type optical disk.

19. The recording and reproducing apparatus according to claim 3, wherein antistatic coatings having the same composition are formed on the opposed surfaces of the attitude control plates and the thin type optical disk.

20. The recording and reproducing apparatus according to claim 4, wherein antistatic coatings having the same composition are formed on the opposed surfaces of the attitude control plates and the thin type optical disk.

21. The recording and reproducing apparatus according to claim 5, wherein antistatic coatings having the same composition are formed on the opposed surfaces of the attitude control plate and the thin type optical disk.

22. The recording and reproducing apparatus according to claim 6, wherein antistatic coatings having the same composition are formed on the opposed surfaces of the attitude control plate and the thin type optical disk.

23. The recording and reproducing apparatus according to claim 7, wherein antistatic coatings having the same composition are formed on the opposed surfaces of the attitude control plates and the thin type optical disk.

24. The recording and reproducing apparatus according to claim 8, wherein antistatic coatings having the same composition are formed on the opposed surfaces of the attitude control plates and the thin type optical disk.

25. A method of controlling an attitude of a thin type optical disk of a recording and reproducing apparatus comprising the thin type optical disk and an attitude control plate of which center placed coaxially with a rotation axis of the thin type optical disk, the attitude control plate controlling the attitude of the thin type optical disk during disk rotation, wherein
a clamp for fixing the attitude control plate and the thin type optical disk to a disk rotation axis is provided with one or more vents penetrating in the disk rotation axis direction,
a spacer for securing a certain clearance between the attitude control plate and the thin type optical disk is provided on a surface of the attitude control plate opposed to the thin type optical disk,
the spacer is provided with one or more vents penetrating in a radial direction of the attitude control plate and the thin type optical disk, and
the attitude control plate and thin type optical disk rotate together and thereby generate a constant air flow between the attitude control plate and the thin type optical disk.

26. A method of controlling an attitude of a thin type optical disk of a recording and reproducing apparatus comprising the thin type optical disk and an attitude control plate of which center placed coaxially with a rotation axis of the thin type optical disk, wherein
a spacer for securing a certain clearance between the attitude control plate and the thin type optical disk is provided on a surface of the attitude control plate opposed to the thin type optical disk,
the attitude control plate is provided with one or more penetrating vents at a position closer to an outer circumference than a mounting position of the spacer, and
the attitude control plate and thin type optical disk rotate together and thereby generate a constant air flow between the attitude control plate and the thin type optical disk.
